(19) United States
(12) Patent Application Publication
(10) Pub. No.: US 2006/0031339 A1
(43) Pub. Date: Feb. 9, 2006

(54) Integration of instant messaging clients with user devices

(75) Inventor: Mark E. Peters, Chapel Hill, NC (US)

Correspondence Address: MARCIA L. DOUBET LAW FIRM, PO BOX 422859, KISSIMMEE, FL, 34742, US

(73) Assignee: International Business Machines Corporation, Armonk, NY (US)

(21) Appl. No.: 10/914,655

(22) Filed: Aug. 9, 2004

(51) Int. Cl. G06F 15/16

(52) U.S. Cl. 709/206

(57) ABSTRACT

Integration of instant messaging software with user devices, thereby enabling a user to communicate with an instant messaging client through an alternative device. A user receives a notification of an incoming instant message through this alternative device, which may be, for example, a cordless telephone. In preferred embodiments, the user can also respond to that notification using the alternative device. Various types of notifications may be supported. For example, when the alternative device has a textual display, the actual instant message (or some portion thereof) may be rendered on that display; a light may flash, or a “beep” may sound, for notification on an alternative device which lacks textual display capability. Similarly, various types of responses may be supported. The user may “type” a textual response, for example, using a keypad of the alternative device or may press a key (or key sequence) associated with a predefined response message.

### BACKGROUND OF THE INVENTION

1. Field of the Invention

The present invention relates to instant messaging software, and deals more particularly with integration thereof with user devices (such as cordless telephones) to enable users to receive, and optionally respond to, information from an instant messaging client without a requirement to be physically near the device on which the client software resides.

2. Description of the Related Art

Instant messaging systems provide for instant, real-time communication between users who are connected to the system through an on-line or electronic networking environment such as the Internet, World Wide Web, or corporate internal intranets. Examples of instant messaging systems include Yahoo!® Messenger, AOL Instant Messenger^{SM}, and Sametime®. (“Yahoo!” is a registered trademark of Yahoo! Inc., “AOL Instant Messenger” is a service mark of America Online, Inc., and “Sametime” is a registered trademark of Lotus Development Corporation.) Such systems are quite popular among users because they are easy to use and provide a simple way for one user to send a message to another user.

Instant messaging systems provide real-time awareness of who is logged on. Typically, an instant messaging system (hereinafter, “IMS”) user has an address book or “buddy list” containing names or nicknames for those people with whom he communicates. The entries in this address book are used for selecting a message recipient. The IMS typically indicates, using a visual cue (such as different icons or different fonts), which of the people are logged on to the system and which are not. When the message sender and the target recipient are both currently logged on to an IMS (which may be the same IMS, or a different IMS), the message can be delivered and presented to the recipient nearly instantly (depending on network delay). Instant messaging systems are well known in the art, and a detailed description thereof is not deemed necessary to an understanding of the present invention.

Users of instant messaging systems are typically communicating with one another from some distance. Thus, it may happen that one IMS user appears to be available for receiving an instant message (e.g., because the IMS is currently presenting that user's status as “logged on”), when in fact, the user has stepped away from an IMS-capable device (such as a computer workstation or laptop computer). If that user is not within range of a hearing an audible “incoming instant message” signal, or within viewing range of seeing a visual incoming message indication, then the sender of the instant message is unable to receive a timely response.

Suppose, for example, that Mary attends a number of meetings throughout a typical day, and often needs to communicate with her assistant, Susan. If Susan is reachable using an IMS, then Mary can send an instant message to Susan during a meeting, even though she typically cannot speak with Susan using a conventional telephone or a cellular phone.

There is an ongoing need to provide more enjoyable and more productive ways for people to communicate and to exchange messages, where these techniques also alleviate some of the disadvantages in communicating at a distance.

### SUMMARY OF THE INVENTION

The present invention provides techniques for integrating instant messaging software with user devices, thereby enabling a user to communicate with an instant messaging client through an alternative device (that is, a device that is distinct from the device where the IMS client software resides). A user can now receive a notification of an incoming instant message through this alternative device, which may be, for example, a cordless telephone. In preferred embodiments, the user can also respond to that notification using the alternative device. Various types of notifications may be supported. For example, when the alternative device has a textual display, the actual instant message (or some portion thereof) may be rendered on that display; a light may flash, or a “beep” may sound, for notification of an incoming instant message on an alternative device which lacks textual display capability. Similarly, various types of responses may be supported. The user may “type” a textual response, for example, using a keypad of the alternative device; or, the user may press a key (or key sequence) on the alternative device, where this key (or key sequence) is associated with a predefined response message.

### BRIEF DESCRIPTION OF THE DRAWINGS

The novel features believed characteristic of the present invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 depicts a system diagram illustrating an environment comprising a plurality of interconnected communication networks of the prior art, in which the present invention may be practiced;

FIG. 2 provides a pictorial diagram of a cordless telephone and receiver base, which may be adapted for use with embodiments of the present invention;

FIG. 3 depicts a block diagram of a cordless telephone, in accordance with a preferred embodiment of the present invention;

FIGS. 4A and 4B illustrate examples of the manner in which a cordless phone user may be notified of an incoming instant message and FIG. 4C is used when discussing an example of the user providing a response thereto from the phone keypad, according to several embodiments of the present invention; and

FIG. 5 depicts a flowchart illustrating logic that may be used when implementing preferred embodiments of the present invention.

### DESCRIPTION OF PREFERRED EMBODIMENTS

The present invention provides techniques for integrating instant messaging software with user devices, thereby enabling users to receive, and optionally respond to, information from an instant messaging client without a requirement to be physically near the device on which the client software resides.

Preferred embodiments will be described herein primarily with reference to using a cordless phone as the alternative device, although this is by way of illustration and not of limitation. According to the present invention, a cordless phone user can now receive an indication of an incoming instant message, and in preferred embodiments, can respond to that message using the cordless phone.

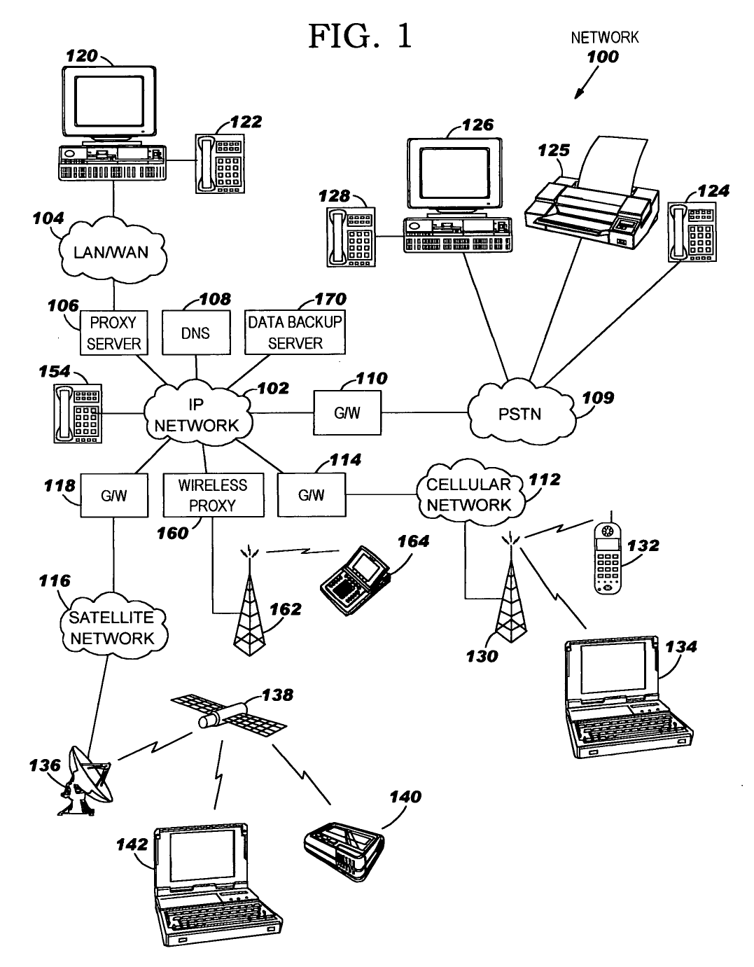

With reference now to the figures, and in particular with reference to FIG. 1, a system diagram illustrating an environment comprising a plurality of interconnected communication networks of the prior art is depicted, in which the present invention may be practiced. As illustrated, an Internet Protocol (“IP”) network 102, a Local Area Network (“LAN”)/Wide Area Network (“WAN”) 104, the Public Switched Telephone Network (“PSTN”) 109, a cellular wireless network 112, and a satellite communication network 116 are illustrative of this environment.

IP network 102 may be the publicly-available IP network known as “the Internet”, a private IP network, or a combination of public and private IP networks. In any case, IP network 102 operates according to the Internet Protocol and routes packets among its many switches and through its many transmission paths. IP networks are generally known in the art to be expandable, fairly easy to use, and widely supported. Coupled to IP network 102 is a Domain Name Server (“DNS”) 108 to which queries may be sent, such queries each requesting an IP address based upon a Uniform Resource Locator (“URL”).

LAN/WAN 104 may couple to IP network 102 via a proxy server 106 (or another connection). LAN/WAN 104 may operate according to various communication protocols, such as the Internet Protocol, the Asynchronous Transfer Mode (“ATM”) protocol, or other known packet-switched protocols. Proxy server 106 serves to route data between IP network 102 and LAN/WAN 104. Although not explicitly shown in FIG. 1, a firewall that precludes unwanted communications from entering LAN/WAN 104 may also be co-located with proxy server 106.

Computer 120 couples to LAN/WAN 104 and supports communications with LAN/WAN 104. Computer 120 may employ the LAN/WAN and proxy server 106 to communicate with other devices across IP network 102. As is also shown, phone 122 couples to computer 120 and may be employed to initiate IP telephony communications with another phone or voice terminal using IP telephony. In such an IP telephony system, a gatekeeper (not explicitly shown in FIG. 1) may be deployed by a service provider to manage IP telephony for its users. An IP-capable phone 154 connected to IP network 102 (or other phone, such as phone 124) may communicate with phone 122 using IP telephony. Such communications are generally known in the art and will not be further described herein.

PSTN 109 is a circuit-switched network that is primarily employed for voice communications, such as those enabled by a phone 124. However, PSTN 109 also supports the transmission of data. Data transmissions may be supported to a tone-based terminal, such as a facsimile machine 125; to a tone-based modem contained in computer 126; or to another device that couples to PSTN 109 via a digital connection, such as an Integrated Services Digital Network (“ISDN”) line, an Asynchronous Digital Subscriber Line (“ADSL”), or another digital connection to a terminal that supports such a connection. As illustrated, a voice terminal, such as phone 128, may couple to PSTN 109 via computer 126 rather than being supported directly by PSTN 109, as is the case with phone 124. Thus, computer 126 may support IP telephony with voice terminal 128, for example.

Cellular network 112 supports wireless communications with terminals operating in its service area (which may cover all or a portion of a city, county, state, country, etc.). As is known, cellular network 112 includes a plurality of towers, illustrated at 130, that each service communications within a respective cell. Wireless terminals that may operate in conjunction with cellular network 112 include wireless handsets 132 and wirelessly-enabled laptop computers 134, for example. Wireless handsets 132 could be, for example, personal digital assistants, wireless or cellular telephones, or two-way pagers. In the sample environment, cellular network 112 couples to IP network 102 via gateway 114.

Wireless handsets 132 and wirelessly-enabled laptop computers 134 may communicate with cellular network 112 using a protocol such as wireless application protocol (“WAP”). WAP is an open, global specification that allows mobile users with wireless devices (such as, for example, mobile phones, pagers, two-way radios, smartphones, communicators, personal digital assistants, and portable laptop computers) to easily access and interact with information and services almost instantly. WAP is a communications protocol and application environment that can be deployed on a variety of operating systems, and provides interoperability between different device families.

Cellular network 112 operates according to an operating standard, which may be the Advanced Mobile Phone System (“AMPS”) standard, the Code Division Multiple Access (“CDMA”) standard, the Time Division Multiple Access (“TDMA”) standard, or the Global System for Mobile Communications or Groupe Speciale Mobile (“GSM”), for example. Independent of the standard(s) supported by cellular network 112, cellular network 112 supports voice and data communications with terminal units, such as 132 and 134.

Satellite network 116 includes at least one satellite dish 136 that operates in conjunction with a satellite 138 to provide satellite communications with a plurality of terminals, such as laptop computer 142 and satellite handset 140. Satellite handset 140 could also be a two-way pager. Satellite network 116 may be serviced by one or more geosynchronous orbiting satellites, a plurality of medium earth orbit satellites, or a plurality of low earth orbit satellites. In any case, satellite network 116 services voice and data communications, and in the sample environment of FIG. 1, couples to IP network 102 via gateway 118.

Wireless proxy 160 is coupled to IP network 102 and is coupled to a plurality of towers, such as 162, which each provide wireless communications with wireless devices such as wireless device 164. Wireless proxy 160 provides access to IP network 102 to wireless device 164, such as a personal digital assistant (“PDA”) or a wireless telephone, that may require proprietary or other special protocols in order to communicate with IP network 102. For example, wireless proxy server 160 may be a 3Com server utilizing 3Com protocols (available from 3Com Corporation in Santa Clara, Calif.) for communicating with a handheld portable computing device often referred to as a “palm device”, an example of which is a Palm VII.

Instant messaging clients may be supported in a number of different types of device, including computers 120, 126 and laptop computers 134, 142, as well as devices connected directly to a carrier, such as 2-way pager 140 and PDA 164.

FIG. 1 is intended as an example, and not as an architectural limitation, of an environment in which the present invention may be practiced. Telephone 122 and/or 128, for example, may leverage techniques disclosed herein to allow their users to participate in instant messaging communication even though the user is not physically near computer 120 or 126. A cordless phone may also be operably connected to another device, such as laptop 134 or 142 (although this has not been depicted in FIG. 1), enabling the user to participate in instant messaging without a requirement for being physically present at the laptop device (which is a type of conventional IMS client device).

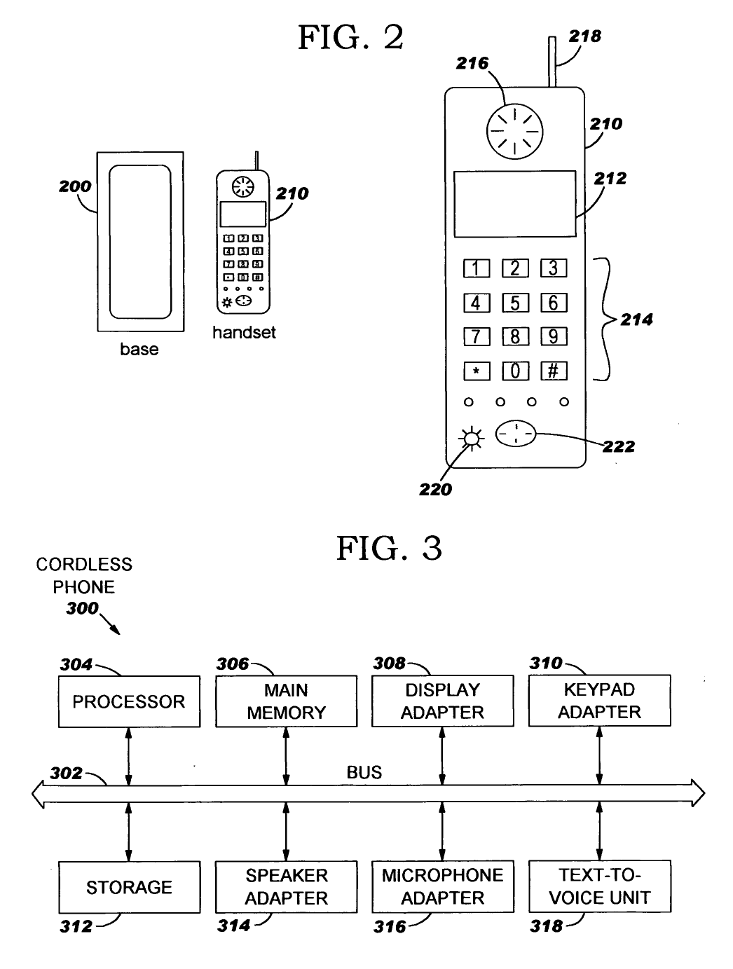

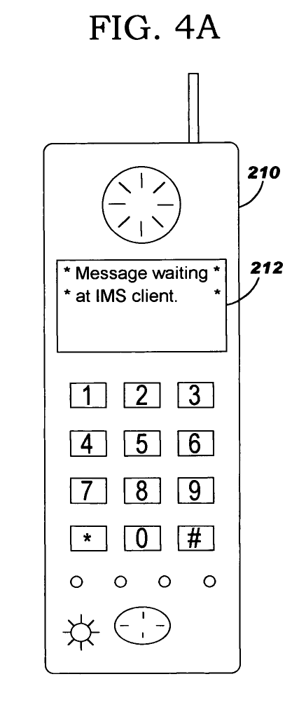

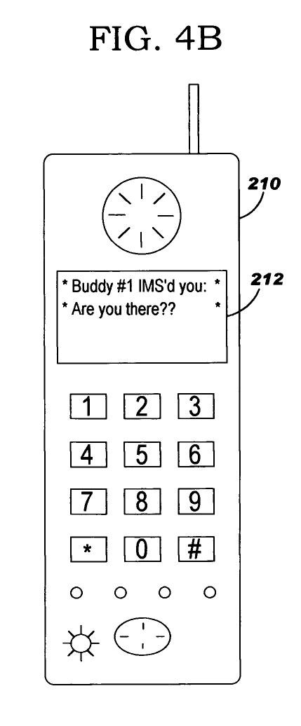

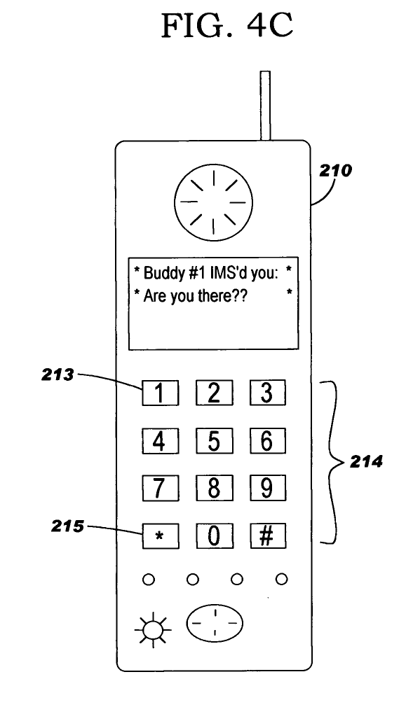

Referring now to FIG. 2, a pictorial diagram is provided comprising a receiver base 200 and a handset 210 for a cordless telephone, which may be adapted for use with embodiments of the present invention. Cordless telephone handset 210 preferably includes a display 212 for presenting textual information (although display 212 is not strictly required, as discussed below). Display 212 may be of a known display device type, such as a liquid crystal display (“LCD”) device. Whereas such a display may be conventionally used to present the telephone number and/or name of a calling party, embodiments of the present invention may leverage this display area for instant messaging information, as discussed in more detail below. (See, for example, FIGS. 4A and 4B.)

Cordless telephone handset 210 may also include keypad 214, speaker 216, antenna 218, visual indicator 220, and microphone 222. In some embodiments, the cordless phone user may use keypad 214 to provide responses to incoming instant messages, as discussed in more detail below. (See, for example, FIG. 4C.)

Speaker 216 provides a mechanism for audio output, such as the voice audio of a party to whom the user of cordless telephone handset 210 may be speaking in a conventional phone conversation. In some embodiments, and in particular when handset 210 lacks a display 212, this speaker 216 may be leveraged to provide an audible notification of an incoming instant message. This audible notification may comprise activating a sound such as one or more “beep” sounds. Or, the phone may be adapted to ring upon receiving the instant message notification (and this ring is preferably distinguishable from the ring associated with a conventional incoming voice call). Alternative notification techniques include audible announcement of a preconfigured message, such as “An instant message has just arrived” or “An instant messaging session has been initiated to your IMS client”. Furthermore, a text-to-voice unit may be provided in the cordless phone, where this unit is capable of interpreting message-specific information (such as the IMS nickname or other identifier of the message sender) associated with an incoming instant message and announcing this information over speaker 216. (Refer to the discussion of element 316 in FIG. 3, below, for more information on this capability.)

Antenna 218 provides a mechanism for handset 210 to communicate with base unit 200. Visual indicator 220 is an optional component of handset 210, and may be used to provide a visual notification that an instant message has arrived for this user. This visual notification may comprise, for example, a flashing light. (Use of a visual indicator on cordless phone base units and/or handsets for signalling the user that a voice message is waiting is known in the art. Preferably, the visual notification for an arriving instant message is readily distinguishable from this message-waiting signal.) Alternatively, an allocated light-emitting diode (“LED”) may be used as a visual indicator of arrival of an instant message.

Microphone 222 provides a mechanism for audio input, such as for enabling the cordless phone user to speak to another person in a conventional phone conversation. Some embodiments of the present invention may leverage microphone 222 for user responses to incoming instant message notifications. In this approach, a user may speak a voice command that is received by microphone 222, where this voice command causes a preconfigured response (such as a stored text message) to be transmitted over the IMS to the client software of the other communicating party. For example, the user of cordless phone handset 210 might speak the word “busy”, thereby activating the transmission, over the IMS, of a previously-associated text message such as “I am currently busy and cannot respond to your message.”.

Alternatives to audibly announcing an incoming instant message or providing a visual notification thereof include causing the cordless phone to ring and/or vibrate. It should be noted that embodiments of the present invention may be provided where the various types of notification occur upon initiation of an instant messaging session with the user's IMS client, and/or upon receipt of each individual instant message (and embodiments of the present invention may allow a user to configure the type of notification). Embodiments of the present invention may optionally allow a user to configure a filter that is applied to notifications of instant messages, such that (for example) only notifications of messages from selected users are forwarded to the cordless phone. Other approaches may also be provided without deviating from the scope of the present invention, such as waiting a predetermined (or configurable) time following receipt of an instant message, and then providing the notification at the cordless phone.

Turning now to FIG. 3, a block diagram of a cordless telephone, in accordance with a preferred embodiment of the present invention, is depicted. Cordless telephone 300 is an example of a cordless telephone, such as cordless telephone 210 in FIG. 2, in which code or instructions implementing processing of the present invention may be located. (It should be noted that, in the case of a cordless phone, responsibility for carrying out processing of the present invention may be shared between the base unit 200 and the handset 210 of a cordless telephone, and the scope of the present invention is not limited to a particular division of responsibility among these components.) Cordless telephone 300 includes a bus 302 to which a processor 304 and main memory 306 are connected. Display adapter 308, keypad adapter 310, storage 312, microphone adapter 316, audio adapter 314, and an optional text-to-voice unit 318 also are connected to bus 302.

Preferably, an operating system runs on processor 304 and is used to coordinate and provide control of various components within cordless telephone 300. Preferably, program code instructions (such as instructions for the operating system and for embodiments of the present invention) are located in storage 312 and are loaded into main memory 306 for execution by processor 304.

The optional text-to-voice unit 318, which was briefly discussed above, may be used with embodiments of the present invention to audibly announce information to the user of cordless phone 300 when an instant message arrives. This audibly-announced information may include, by way of example, the nickname of the message sender, a configurable or fixed number of introductory words from the message, or the entire message. When this component is present, an implementation of the present invention may optionally support a single type of audibly-announced information (such as only nicknames, or only the first 3 words) or multiple types, and may optionally allow the user to configure this choice.

Those of ordinary skill in the art will appreciate that the components depicted in FIG. 3 may vary depending on a particular user device. Other internal components or peripheral devices, such as flash read-only memory (“ROM”), other nonvolatile memory, or optical disk drives and the like may be used in addition to (or in place of) the components depicted in FIG. 3.

In one approach, cordless phone 300 is integrated with a user's existing IMS client via a Universal Serial Bus (“USB”) port added to the cordless phone base. Information may be transmitted between the IMS client (which resides, for example, on computer 120 or laptop 142 of FIG. 1) and the cordless phone base. This transmission to the cordless phone may occur following expiration of a fixed or configurable time period after receiving an instant message at the IMS client, during which the user of the IMS client fails to respond, thus suggesting that the user is unavailable for communicating directly from the IMS client. In addition or instead, the IMS client software may be adapted for allowing the user to explicitly indicate when transmissions should be forwarded to the cordless phone. For example, suppose Susan, a user of an IMS client, is working in a home office and anticipating an instant message from another user, Mary, and Susan suddenly finds that she must step away from physical proximity to the device upon which her IMS client is installed. A mechanism may be provided in Susan's IMS client, such as a clickable graphical button on the IMS user interface, with which Susan can indicate “forward notifications to my cordless phone”. Alternatives include allowing Susan to select this notification forwarding from a menu presented by her IMS client or using a special key or key strokes which are then interpreted by the IMS client as indicating that the forwarding should commence. As another alternative, an embodiment of the present invention might be set up to always simulcast to the cordless phone.

In another approach, rather than using a USB port, transmissions between the IMS client and cordless phone 300 may occur using a wireless communication protocol such as Bluetooth or IEEE 802.11. (These communication protocols are well known in the art, and a detailed discussion thereof is not deemed necessary to an understanding of the present invention.)

Other communication mechanisms for integrating the IMS client and cordless phone may be used without deviating from the scope of the present invention.

Turning now to FIG. 4A, an example is provided showing how the cordless phone handset 210 of FIG. 2 may appear when an instant message notification is rendered on its display 212. In this example, the display includes a notification that an instant message is awaiting the user at his or her IMS client device. FIG. 4B illustrates another approach, where message-specific information is rendered on display 212. In this example, the message-specific information indicates that an instant message from the user with IMS nickname “Buddy #1” has arrived at the user's IMS client, and that the first 15 characters of this message are “Are you there??”. An embodiment of the present invention may be adapted for providing additional or different information, such as the time of day of an arriving instant message. An embodiment of the present invention may also enable the user to scroll displayed messages, for example by using keys on the handset keypad to scroll up and down or left and right.

FIG. 4C illustrates one manner in which the user of cordless telephone handset 210 may use keypad 214 to provide responses to incoming instant messages. The user might press key 213, for example, as a signal to be transmitted to the user's IMS client, causing the IMS client to transmit a preprogrammed response such as “Be with you in a minute”. (The translation between the user-pressed key and the preprogrammed response may alternatively be performed in the base 200 or handset 210 of cordless phone, after which the preprogrammed response is transmitted to the IMS client.) Or, the user might press key 215, as another example, thereby signalling that a message such as “Your message arrived” or “I am busy right now” should be sent to the other IMS user. Also, if the cordless phone is currently being used and the IMS is set to use the phone, then a “busy” indication might be returned to the remote IMS user and the incoming instant message information may be queued up until after the phone conversation ends. Alternatively, the cordless phone might beep locally and show the incoming instant message information on the handset in this situation.

When the cordless phone is adapted for providing responses of the type described with reference to FIG. 4C, the selection of available responses may be fixed by the embodiment; or, a mechanism may be provided that allows the user to customize the selection. As an example of the latter approach, the user may type message text into a configuration panel of the IMS client and then indicate which key on keypad 214 should be associated with that message.

In another approach, not shown in the figures, a user may verbally respond to the notification of an arriving instant message, as was briefly discussed above with reference to speaker 222. Embodiments supporting this approach may be adapted for using a keyword-based approach, whereby the user speaks a word or short phrase which is associated with a stored textual message that will then be sent to the other IMS user. Or, a voice-to-text unit may be provided, whereby the user's entire spoken message is translated into a textual message that will be sent to the other IMS user. (This optional translation unit may be resident in the handset 210, base 200, or in the local computing device in which the IMS client resides. In this latter scenario, the local computing device may have been previously trained to recognize the local user's voice.)

Optionally, embodiments of the present invention may allow cordless phone users to control settings of their IMS clients from the cordless phone. For example, a key on keypad 214 might be adapted for signalling the IMS client to switch to “do not disturb” mode (such that the IMS client will not accept new inbound instant messages). Other optional features of embodiments of the present invention include automatically notifying the IMS client to reset its “away” timer responsive to stimuli such as a phone being taken “off hook” or used (e.g., for a conventional voice call) or being moved.

Automated responses to notification of an instant message may be supported by embodiments of the present invention, if desired. For example, a particular response may be selected based on factors such as the current time of day or the identity of the message sender. The cordless phone user may be allowed to explicitly enable and disable this automated response feature (using, for example, a specific key on keypad 214 or a menu selection in the IMS client).

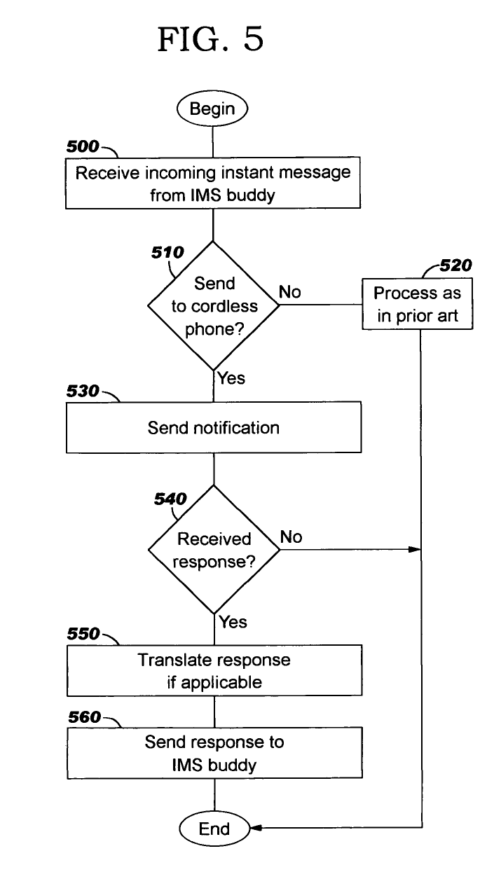

FIG. 5 depicts a flowchart illustrating logic that may be used when implementing preferred embodiments of the present invention, and provides a high-level view of processing carried out in an IMS client that has been integrated with a cordless phone as described herein. In Block 500, an instant message from an IMS user (referred to as an “IMS buddy” in FIG. 5) arrives. Block 510 tests to see if a notification of this message should be sent to a cordless phone. As discussed earlier, a user may explicitly configure his or her IMS client to forward these notifications, or notifications may be sent responsive to other factors such as determining that a response to the arriving message is not provided by the user within a particular time period. When the test in Block 510 has a negative result (i.e., a notification will not be forwarded to the cordless phone for this message), control transfers to Block 520 where the message is preferably processed using prior art techniques. The processing of this message is then complete.

When the test in Block 510 has a positive result, on the other hand, control reaches Block 530, where a notification of the arriving message (and optionally, information such as the sender's nickname and/or the message text or some portion thereof) is forwarded to the cordless phone. Block 540 then determines (preferably, after a time period has elapsed) whether a response to the message notification has been received from the cordless phone. If not, this may be an indication that the cordless phone user did not receive the notification. Or, some embodiments of the present invention may not be adapted for accepting or transmitting user responses. At any rate, following a negative result to the test in Block 540, processing of this message is then complete.

When Block 540 determines that a response has been received from the cordless phone, translation thereof may optionally be supported (Block 550). Examples of this translation include looking up the message text associated with a keypad entry, translating a spoken message to text for transmission over the IMS, and translating a key sequence received on the cordless phone keypad into a text message. (As an example of the latter translation, so-called “predictive autodialing” techniques may be used, whereby entries provided on a numeric keypad are evaluated to programmatically deduce which of the several letters typically associated with each such key was intended by the user. For example, if the user pressed the “2” key followed by the “8” key, a programmatic deduction may be made that the user intended this to represent the word “at”—since no other combination of 2 letters selected from “ABC”, associated with the 2 key, and “TUV”, associated with the 8 key, forms a word. Or, using an older approach, the key sequence “2##8#” might be translated to the word “at” in Block 550, where in this older approach, the user first presses a key associated with several different letters and then presses the “#” key some number of times to signal which of those letters is intended.)

At Block 560, the response received from the cordless phone user (or the translated version thereof, as appropriate) is transmitted over the IMS to the IMS buddy. The processing of this message is then complete.

Preferred embodiments have been described herein with reference to cordless phones having a handset that is not physically connected to its base. Use of such phones may be advantageous in many environments, such as when a person wishes to have access to a phone (and/or to features provided by embodiments of the present invention) without remaining in physical proximity to a telephone unit that is connected to a telephone jack. However, embodiments of the present invention may be deployed on phone units that are not cordless, without deviating from the scope of the present invention. For example, a user may have a number of phones located throughout his or her home, and embodiments of the present invention may forward notifications (and optionally, other message information) to such phones in a similar manner to that which has been described herein for cordless phones. Notably, the phone device need not be dedicated to use as an extension of the user's IMS client, and preferably continues to function as a telephone as well.

In other embodiments, the instant messaging software may be integrated with devices that provide (at least 1-way) communication with users but which do not function as telephones. Examples of such devices include status display areas used with home automation features on home appliances, where message notifications may be presented (e.g., as textual messages or by flashing an LED). Responses may optionally be supported from such devices if a keypad, voice recognition unit, or other entry means is available. In these embodiments, communication with the user's IMS client preferably occurs using wireless means (such as the previously-discussed Bluetooth or IEEE 802.11 protocols).

As has been demonstrated, the present invention provides advantageous techniques that enable integration of instant messaging with various user devices. These techniques may provide more enjoyable and more productive ways for people to communicate and to exchange messages, and are expected to alleviate some of the disadvantages in communicating at a distance. When added to cordless phones, features as disclosed herein may enable manufacturers of those phones to exploit new marketing strategies and/or to be more competitive with manufacturers of devices such as cellular phones.

As will be appreciated by one of skill in the art, embodiments of the present invention may be provided as methods, systems, or computer program products comprising computer-readable program code. Accordingly, the present invention may take the form of an entirely hardware embodiment, an entirely software embodiment, or an embodiment combining software and hardware aspects. The computer program products maybe embodied on one or more computer-usable storage media (including, but not limited to, disk storage, CD-ROM, optical storage, and so forth) having computer-readable program code embodied therein.

When implemented by computer-readable program code, the instructions contained therein may be provided to a processor of a general purpose computer, special purpose computer, embedded processor, or other programmable data processing apparatus to produce a machine, such that the instructions, which execute via the processor of the computer or other programmable data processing apparatus, create means for implementing embodiments of the present invention.

These computer-readable program code instructions may also be stored in a computer-readable memory that can direct a computer or other programmable data processing apparatus to function in a particular manner, such that the instructions stored in the computer-readable memory produce an article of manufacture including instruction means which implement embodiments of the present invention.

The computer-readable program code instructions may also be loaded onto a computer or other programmable data processing apparatus to cause a series of operational steps to be performed on the computer or other programmable apparatus to produce a computer-implemented method such that the instructions which execute on the computer or other programmable apparatus provide steps for implementing embodiments of the present invention.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

What is claimed is:

1. A method of integrating instant messaging with user devices, comprising steps of:
forwarding notification information from an instant messaging system (“IMS”) client to a user device, wherein the user device is distinct from a device on which the IMS client resides; and
rendering a notification of the forwarded notification information on the user device, such that a user of the user device can be notified thereof.

2. The method according to claim 1, wherein the forwarded notification information comprises a notification that an instant message has arrived at the IMS client.

3. The method according to claim 1, wherein the forwarded notification information comprises a notification that an instant message from a selected message sender has arrived at the IMS client.

4. The method according to claim 1, wherein the forwarded notification information comprises a notification that an instant messaging session has been initiated at the IMS client.

5. The method according to claim 1, wherein the forwarded notification information comprises an identification of a sender of an instant message that has arrived at the IMS client.

6. The method according to claim 1, wherein the forwarded notification information comprises a nickname of a sender of an instant message that has arrived at the IMS client.

7. The method according to claim 1, wherein the forwarded notification information comprises an arrival time of an instant message that has arrived at the IMS client.

8. The method according to claim 1, wherein the forwarded notification information comprises text of an instant message that has arrived at the IMS client.

9. The method according to claim 1, wherein the forwarded notification information comprises a portion of text of an instant message that has arrived at the IMS client.

10. The method according to claim 1, wherein the rendered notification comprises a visual rendering thereof.

11. The method according to claim 10, wherein the visual rendering comprises rendering a textual message on a display of the user device.

12. The method according to claim 10, wherein the visual rendering comprises activating a light on the user device.

13. The method according to claim 1, wherein the rendered notification comprises an audible rendering thereof.

14. The method according to claim 13, wherein the audible rendering comprises activating a sound from the user device.

15. The method according to claim 13, wherein the audible rendering comprises causing the user device to provide an audible announcement.

16. The method according to claim 1, further comprising the steps of:
accepting, at the user device, a user response to the rendered notification; and
returning the accepted user response from the user device to the IMS client, for transmission to a sender of an instant message that triggered the forwarding step.

17. The method according to claim 16, wherein the user response is accepted from a keypad of the user device.

18. The method according to claim 16, wherein the user response is accepted from a microphone of the user device.

19. The method according to claim 1, further comprising the steps of:
accepting, at the user device, a user response to the rendered notification;
translating the user response to a response message associated therewith; and
returning the response message from the user device to the IMS client, for transmission to a sender of an instant message that triggered the forwarding step.

20. The method according to claim 1, wherein the user device is a telephone.

21. The method according to claim 1, wherein the user device is a home automation status device.

22. The method according to claim 2, wherein the forwarding step occurs responsive to receiving the instant message at the IMS client.

23. The method according to claim 2, wherein the forwarding step occurs responsive to receiving the instant message at the IMS client, without receiving a response thereto.

24. The method according to claim 2, wherein the forwarding step occurs responsive to receiving the instant message at the IMS client, without receiving a response thereto within a particular time period.

25. The method according to claim 1, wherein the user device is a cordless telephone base and the device on which the IMS client resides is a personal computer.

26. The method according to claim 1, further comprising the steps of:
accepting user input, at the user device, to alter a setting of the IMS client;
forwarding the accepted user input from the user device to the device on which the IMS client resides; and
altering the setting, responsive to receiving the forwarded user input at the IMS client.

27. A system for integrating instant messaging with user devices, comprising:
means for forwarding notification information from an instant messaging system (“IMS”) client to a user device, wherein the user device is distinct from a device on which the IMS client resides; and
means for rendering a notification of the forwarded notification information on the user device, such that a user of the user device can be notified thereof.

28. A computer program product for integrating instant messaging with user devices, the computer program product embodied on one or more computer-readable media and comprising computer-readable instructions for:
forwarding notification information from an instant messaging system (“IMS”) client to a user device, wherein the user device is distinct from a device on which the IMS client resides; and
rendering a notification of the forwarded notification information on the user device, such that a user of the user device can be notified thereof.
